(19) United States
(12) Patent Application Publication
(10) Pub. No.: US 2021/0350506 A1
(43) Pub. Date: Nov. 11, 2021

(54) METHOD AND APPARATUS FOR PROCESSING IMAGE, IMAGING DEVICE AND STORAGE MEDIUM

(71) Applicant: SHANGHAI HARVEST INTELLIGENCE TECHNOLOGY CO., LTD., Shanghai (CN)

(72) Inventor: Lee Ya-Ti CHANG, Shanghai (CN)

(73) Assignee: SHANGHAI HARVEST INTELLIGENCE TECHNOLOGY CO., LTD., Shanghai (CN)

(21) Appl. No.: 17/316,905

(22) Filed: May 11, 2021

(30) Foreign Application Priority Data
May 11, 2020 (CN) 202010395146.6
May 11, 2020 (CN) 202010395340.4

(51) Int. Cl. G06T 5/00; G06T 5/50; G06K 9/62

(52) U.S. Cl. CPC G06T 5/002; G06K 9/6215; G06T 5/50

(57) ABSTRACT

The present disclosure provides a method and an apparatus for processing an image, an imaging device and a storage medium. The method includes: acquiring a to-be-processed blurred image, and determining an initial blur function and an initial clear image; and acquiring a processed clear image and a processed blur function based on an iterative operation of a blurred image, a blur function and a clear image. Embodiments of the present disclosure can deblur the blurred image by the iterative operation to obtain a clear image with higher quality.

### CROSS-REFERENCE TO RELATED APPLICATIONS

The present application claims the benefit of priority to Chinese patent application No. 202010395146.6, filed on May 11, 2020, entitled “Method and Apparatus for Processing Blur Function Used with Imaging System, Image Capturing Device and Storage Medium,” the entire disclosure of which is hereby incorporated herein by reference. The present application also claims the benefit of priority to Chinese patent application No. 202010395340.4, filed on May 11, 2020, entitled “Method and Apparatus for Deblurring Image, Imaging Device and Storage Medium,” the entire disclosure of which is hereby incorporated herein by reference.

### TECHNICAL FIELD

The present disclosure relates to the technical field of image processing, and more particularly to a method and an apparatus for processing an image, an imaging device and a storage medium.

### BACKGROUND

In an image capturing process such as taking pictures, a movement of a captured object may cause a blurred image. For example, in a fingerprint identification scene, if a finger moves during imaging of a sensor, an image received by the sensor is blurred due to a movement of the finger, which causes the fingerprint cannot be effectively identified.

In view of above problem of the blurred image, a current solution is usually to shoot another clear image, but this prolongs a shooting period. For example, in a fingerprint unlocking scene, when a fingerprint needs to be continuously recaptured due to a continuous movement of a finger, too long unlocking time may affect the user experience.

### SUMMARY

Embodiments of the present disclosure provide a method and an apparatus for processing an image, which can effectively deblur a blurred image to get a clear image.

An embodiment of the present disclosure method for processing an image. The method includes: acquiring a to-be-processed blurred image, and determining an initial blur function and an initial clear image; and acquiring a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation.

In some embodiment, the method further includes: stopping the iterative operation when an iterative operation result satisfies a stopping condition, and determining a processed clear image obtained from a last iterative operation as a deblurring result of the to-be-processed blurred image, so as to restore the to-be-processed blurred image to a corresponding clear image.

In some embodiment, the method further includes: determining a processed blur function obtained from the last iterative operation as an optimal blur function.

In some embodiment, the stopping condition at least includes that a similarity between two processed clear images respectively obtained from two adjacent iterative operations is greater than or equal to a preset threshold.

In some embodiment, both the to-be-processed blurred image and the corresponding clear image are fingerprint images.

In some embodiment, the blur function includes a matrix, and determining the initial blur function includes assigning a random value to each element of the matrix to obtain the initial blur function.

In some embodiment, the random value ranges from 0 to 1.

In some embodiment, the to-be-processed blurred image is captured by an imaging module, and numbers of rows and numbers of columns of the matrix are determined according to a size of a light source of the imaging module.

In some embodiment, determining the initial clear image includes: determining the to-be-processed blurred image as the initial clear image.

In some embodiment, acquiring a processed clear image and a processed blur function based on an iterative operation of a blurred image, a blur function and a clear image includes: performing a deconvolution operation iteratively based on the blurred image, the blur function and the clear image to obtain the processed clear image and the processed blur function.

In some embodiment, performing a deconvolution operation iteratively based on the blurred image, the blur function and the clear image to obtain the processed clear image and the processed blur function includes: obtaining the processed clear image in each iterative operation according to following formula:

$${f}_{k + 1} ( x ) = \{ [ \frac{g ( x )}{{f}_{k} ( x ) * {h}_{k} ( x )} ] * {h}_{k} ( - x ) \} \times {f}_{k} ( x ) ; \qquad$$

wherein, k represents a kth iterative operation, and k≥0, ƒₖ₊₁(x) represents a processed clear image obtained from a (k+1)th iterative operation, ƒₖ(x) represents a processed clear image obtained from the kth iterative operation, g(x) represents the blurred image, hₖ(x) represents a processed blur function obtained from the kth iterative operation, hₖ(−x) represents an inversion of the processed blur function obtained from the kth iterative operation, * represents a convolution operation, and × represents a multiplication operation; and obtaining the processed blur function in each iterative operation according to following formula:

$${h}_{k + 1} ( x ) = \{ [ \frac{g ( x )}{{f}_{k} ( x ) * {h}_{k} ( x )} ] * {f}_{k} ( - x ) \} \times {h}_{k} ( x ) ; \qquad$$

wherein hₖ₊₁(x) represents a processed blur function obtained from a (k+1)th iterative operation, and ƒₖ(−x) represents an inversion of the processed clear image obtained from the kth iterative operation.

In some embodiment, the blur function includes a matrix, and a processed clear image obtained from each iterative operation satisfies following condition: a grayscale of each pixel in the processed clear image is greater than zero.

In some embodiment, the blur function includes a matrix, and a processed blur function obtained from each iterative operation satisfies following conditions: a value of each element in the processed blur function is greater than zero; the processed blur function satisfies a normalization condition; and numbers of rows and numbers of columns of the processed blur function remains constant.

In some embodiment, the stopping condition includes: a preset number of iterative operations are performed.

In some embodiment, stopping the iterative operation when an iterative operation result satisfies a stopping condition includes: when the preset number of iterative operations are reached, but a similarity between a processed clear image obtained from a last iterative operation and a processed clear image obtained from a previous iterative operation adjacent to the last iterative operation is less than a preset threshold, continuing with the iterative operation until the similarity between two processed clear images respectively obtained from two adjacent iterative operations is greater than or equal to the preset threshold.

Another embodiment of the present disclosure provides an apparatus for processing an image. The apparatus includes: an acquisition module, configured to acquire a to-be-processed blurred image and determine an initial blur function and an initial clear image; and a processing circuitry, configured to acquire a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation.

In some embodiment, the apparatus further includes: a determination circuitry, configured to stop the iterative operation when an iterative operation result satisfies a stopping condition, and determine a processed clear image obtained from a last iterative operation as a deblurring result of the to-be-processed blurred image, so as to restore the to-be-processed blurred image to a corresponding clear image.

In some embodiment, the determination circuitry is further configured to determine a processed blur function obtained from the last iterative operation as an optimal blur function.

In some embodiment, the stopping condition at least includes that a similarity between two processed clear images respectively obtained from two adjacent iterative operations is greater than or equal to a preset threshold.

Another embodiment of the present disclosure provides an apparatus for processing a blur function used with an imaging module. The apparatus includes: an acquisition module, configured to acquire a blurred image and determine an initial blur function and an initial clear image; an iterative circuitry, configured to acquire a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation; and a determination circuitry, configured to determine a processed blur function obtained from the last iterative operation as an optimal blur function.

In some embodiment, the stopping condition at least includes that a similarity between two processed clear images respectively obtained from two adjacent iterative operations is greater than or equal to a preset threshold.

Another embodiment of the present disclosure provides a non-transitory storage medium having computer instructions stored therein, wherein the computer instructions are executed to perform steps of the method according to embodiments of the present disclosure.

Another embodiment of the present disclosure provides an imaging device. The imaging device includes: an imaging module, configured to capture a to-be-processed blurred image; and a processing module, configured to perform the method according to embodiments of the present disclosure to deblur and restore the to-be-processed blurred image to a corresponding clear image.

Compared with conventional technologies, embodiments of the present disclosure have following beneficial effects.

According to an embodiment of the present disclosure, the method includes: acquiring a to-be-processed blurred image, and determining an initial blur function and an initial clear image; and acquiring a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation.

Furthermore, the method includes: stopping the iterative operation when an iterative operation result satisfies a stopping condition, and determining a processed clear image obtained from a last iterative operation as a deblurring result.

Therefore, some embodiment of the present disclosure can deblur the blurred image by the iterative operation to obtain a clear image with higher quality. Specifically, a clear image can be obtained from the blurred image by a calculation operation.

Furthermore, the method also includes: determining a processed blur function obtained from the last iterative operation as an optimal blur function. The optimal blur function can be used for deblurring currently captured blurred image.

Furthermore, the stopping condition at least includes that a similarity between two processed clear images respectively obtained from two adjacent iterative operations is greater than a preset threshold. When the similarity between two processed clear images respectively obtained from two consecutive times of iterative operations is higher than the preset threshold, it indicates that a restoration effect of the last iterative operation is better and tends to be stable, thus the clear image obtained from the last iterative operation can be determined as an optimal clear image.

Compared with solutions where fixed number of times of iterative operation is taken as the stopping condition, taking an image similarity as the stopping condition can obtain a better deblurring effect. In particular, too many or too few times of iterative operations may affect the quality of the blur function and a restoration degree of the blurred image. Therefore, the deblurring effect of the image processed by taking fixed number of iterative operation as the stopping condition is not necessarily the best. Based on this, some embodiment of the present disclosure takes the image similarity as the stopping condition, and determines a stopping time according to a real-time processing effect of the iterative operation, thereby obtaining a clearer image with higher quality and a better optimal blur function.

By adopting the scheme of the embodiment, the captured blurred image can be deblurred, and the clear image can be obtained without repeated capturing. Thus, the imaging and identification efficiency of a fingerprint imaging apparatus can be improved, and an identification time can be shortened.

### BRIEF DESCRIPTION OF THE DRAWINGS

FIG. 1 is a flow chart of a method for processing a blur function used with an imaging module according to an embodiment of the present disclosure;

FIG. 2 is a schematic diagram of a clear fingerprint image of a finger;

FIG. 3 is a schematic diagram of a blurred fingerprint image of the finger;

FIG. 4 is a theoretical schematic diagram of a blur function caused by a movement of the finger;

FIG. 5 is a schematic diagram of a blur function obtained from processing the image shown in FIG. 3 using the method shown in FIG. 1;

FIG. 6 is a flow chart of a method for processing an image according to an embodiment of the present disclosure;

FIG. 7 is a schematic diagram of a blurred fingerprint image in a typical application scenario;

FIG. 8 is a schematic diagram of a clear fingerprint image obtained by deblurring and restoring the image shown in FIG. 7;

FIG. 9 is a schematic diagram of a blur function obtained from processing the image shown in FIG. 7 using the method in this embodiment;

FIG. 10 is a schematic diagram showing a structure of an apparatus for processing a blur function used with an imaging module according to an embodiment of the present disclosure; and

FIG. 11 is a schematic diagram showing a structure of an apparatus for processing an image according to an embodiment of the present disclosure.

### DETAILED DESCRIPTION

As mentioned in the background, the movement of the captured object may cause the blurred image, which causes a problem that the fingerprint cannot be effectively identified.

Taking a fingerprint identification scene as an example, traditional optical under-screen fingerprint identification technology uses a lens to image on a sensor, so elements such as a lens array, a light collimator, and a spatial filter are needed, and thus the structure is relatively complicated, which causes shortcomings such as heavy and thick modules and small sensing range. Embodiments of the present disclosure adopts a new optical under-screen fingerprint identification technology, which is based on the principle of total reflection imaging and has the advantages of simple structure, light and thin modules, low cost, and easy realization of a large-area sensing range.

However, during capturing a fingerprint, the finger may move during imaging of the sensor, an image received by the sensor is blurred due to the movement of the finger, thus the fingerprint cannot be effectively identified.

An embodiment of the present disclosure provides a method for processing an image. The method includes: acquiring a to-be-processed blurred image, and determining an initial blur function and an initial clear image; and acquiring a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation. Further, the method includes: stopping the iterative operation when an iterative operation result satisfies a stopping condition, and determining a processed clear image obtained from a last iterative operation as a deblurring result.

Further, the method includes: determining a processed blur function obtained from the last iterative operation as an optimal blur function.

Some embodiment of the present disclosure can deblur the blurred image by the iterative operation to obtain a clear image with higher quality. Specifically, the clear image is obtained from the blurred image by a calculation operation. Further, when a similarity between two processed clear images respectively obtained from two adjacent iterative operations is higher than or equal to the preset threshold, it indicates that a restoration effect of the last iterative operation is better and tends to be stable, thus the clear image obtained from the last iterative operation can be determined as an optimal clear image. Further, the processed blur function obtained from the last iterative operation is determined as an optimal blur function. The optimal blur function can be used for deblurring currently captured blurred image.

In order to make above objects, features and beneficial effects of the present disclosure more obvious and understandable, specific embodiments of the present disclosure are described in detail in combination with the drawings.

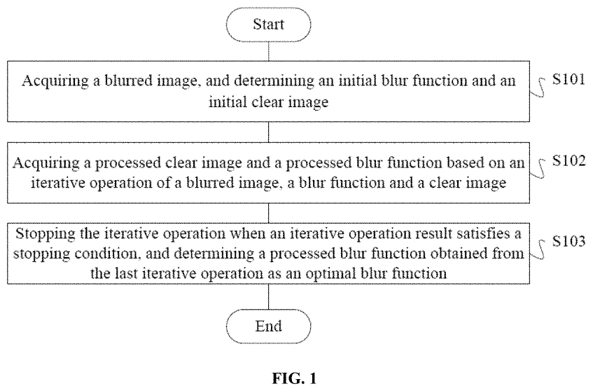

FIG. 1 is a flow chart of a method for processing a blur function according to an embodiment of the present disclosure.

The blur function obtained according to some embodiment can be applied to an optical under-screen fingerprint identification scene. For example, it is possible to perform a deblurring process on the captured blurred fingerprint image based on the blur function to restore the blurred fingerprint image to a clear fingerprint image without repeating fingerprint capturing operations. In practical applications, the blur function can also be applied to other scenes that require post-processing of the captured image that is blurred due to the movement of the captured object, so as to obtain a clear image based on restoring the blurred image.

In the optical under-screen fingerprint identification scene, an imaging module may include: a light source component, a light-transmitting cover plate, and a sensor component. Light emitted from the light source is totally reflected at the light-transmitting cover plate, and incident onto the sensor component with carrying fingerprint information of a finger pressed on the light-transmitting cover plate. The sensor component collects and obtains a fingerprint image.

If the finger moves during imaging of the sensor component, the sensor component collects a blurred fingerprint image. With the solution of some embodiment of the present disclosure, the blurred fingerprint image can be deblurred based on the blur function generated by the movement of the finger to obtain the clear fingerprint image.

A relationship among a clear image, a blurred image and a blur function satisfies formula (1):

g(x)=h(x)*ƒ(x)+n (1)

wherein, g(x) represents the blurred image, h(x) represents the blurred function, ƒ(x) represents the clear image, * represents a convolution operation, n represents system noise, and (x) represents a pixel matrix of an image.

The system noise n can be obtained by measuring the imaging module. For example, an image capturing operation is performed when no finger is placed on the light-transmitting cover plate to obtain an image without an object to be captured. The system noise n is usually used to characterize sensor noise and environmental signal noise, and so on.

The clear image f(x) and the blurred image g(x) can be regarded as a matrix of pixels.

The blur function h(x) can also be expressed in the form of a matrix.

In some embodiment, the blur function h(x) is a point spread function (PSF), which describes a response of an imaging module to a point light source. Therefore, a result of a convolution of the point spread function h(x) and the clear image f(x) (that is, an intrinsic image of the captured object) is the image g(x) (that is, the blurred image) actually captured by the imaging module. Here, the number of rows and columns of the matrix used to characterize the blur function h(x) can be determined according to a size of a light source of the imaging module. For example, the larger the area of the light source component, the greater the number of rows and columns of the matrix. In addition to a shape and size of the light source itself, the movement of the captured object also affects the blur function h(x). A final blur function h(x) is formed by a superposition of the shape and size of the light source and the movement of the captured object.

In some embodiment, with reference to FIG. 1, the method for processing a blur function may include following steps.

S101, acquiring a blurred image, and determining an initial blur function and an initial clear image.

S102, acquiring a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation.

In some embodiment, the method further includes: S103, stopping the iterative operation when an iterative operation result satisfies a stopping condition, and determining a processed blur function obtained from the last iterative operation as an optimal blur function.

In some embodiment, the stopping condition at least includes that a similarity between two processed clear images respectively obtained from two adjacent iterative operations is greater than or equal to a preset threshold.

In some embodiment, in S101, after receiving a to-be-processed blurred image, a blur degree of the blurred fingerprint image may be determined first. If the blur degree of the blurred fingerprint image exceeds a preset critical value, S102 is executed; otherwise, a fingerprint identification operation is directly performed on the blurred fingerprint image.

In some embodiment, S101 further includes: assigning a random value to each element of a matrix of the blur function to obtain the initial blur function.

For example, the random value ranges from 0 to 1. That is, for each element in the matrix of the blur function, random values are selected from 0 to 1 to obtain the initial blur function.

In some embodiment, S101 further includes: determining the blurred image as the initial clear image.

In some embodiment, the blurred image may be an image received by the sensor component.

In some embodiment, S102 may include: performing a deconvolution operation in each iterative operation. The deconvolution operation may be performed based on the maximum likelihood principle.

In some embodiment, the processed clear image may be obtained from each iterative operation according to formula (2):

$${f}_{k + 1} ( x ) = \{ [ \frac{g ( x )}{{f}_{k} ( x ) * {h}_{k} ( x )} ] * {h}_{k} ( - x ) \} \times {f}_{k} ( x ) \qquad ( 2 )$$

wherein, k represents a kth iterative operation, and k≥0, ƒₖ₊₁(x) represents a processed clear image obtained from a (k+1)th iterative operation, ƒₖ(x) represents a processed clear image obtained from the kth iterative operation, g(x) represents the blurred image, hₖ(x) represents a processed blur function obtained from the kth iterative operation, hₖ(−x) represents an inversion of the processed blur function obtained from the kth iterative operation, * represents a convolution operation, and x represents a multiplication operation.

In some embodiment, the processed blur function may be obtained from each iterative operation according to formula (3):

$${h}_{k + 1} ( x ) = \{ [ \frac{g ( x )}{{f}_{k} ( x ) * {h}_{k} ( x )} ] * {f}_{k} ( - x ) \} \times {h}_{k} ( x ) \qquad ( 3 )$$

wherein hₖ₊₁(x) represents a processed blur function obtained from a (k+1)th iterative operation, and ƒₖ(−x) represents an inversion of the processed clear image obtained from the kth iterative operation.

In some embodiment, a processed clear image obtained from each iterative operation satisfies following condition: a grayscale of each pixel in the processed clear image is greater than zero.

In some embodiment, a processed blur function obtained from each iterative operation satisfies following conditions: a value of each element in the processed blur function is greater than zero, the processed blur function satisfies a normalization condition, and the number of rows and the number of columns of the processed blur function remains constant.

Satisfying the normalization condition includes that a sum of all elements in the matrix of the processed blur function is 1.

In some embodiment, after each iterative operation, a check operation can be performed to determine whether the stopping condition is satisfied. If a similarity between the processed image obtained from the (k+1)th iteration and the processed image obtained from the kth iteration is greater than or equal to the preset threshold, the stopping condition is satisfied.

Specifically, the preset threshold may be determined according to an empirical rule, for example, the preset threshold may be measured through previous experiments. Generally speaking, when the iterative operation satisfies the stopping condition, an average minimum error number will be reached.

In some embodiment, the similarity of the images may be characterized based on structural similarity index (SSIM).

In some embodiment, the stopping condition includes: a preset number of times of iterative operations are performed. Thus, a better blur function can be obtained with the aid of secondary inspection.

For example, when the preset number of times of iterative operations are performed, but a similarity between a processed clear image obtained from a last iterative operation and a processed clear image obtained from a previous iterative operation adjacent to the last iterative operation is less than a preset threshold, the iterative operation is still performed until the similarity between two processed clear images respectively obtained from two adjacent iterative operations is greater than or equal to the preset threshold.

For another example, when the times of the iterative operations does not reach the preset number, but a similarity between the processed clear image obtained from the last iterative operation and the processed clear image obtained from the previous iterative operation adjacent to the last iterative operation is greater than or equal to the preset threshold, the iterative operation can be stopped immediately.

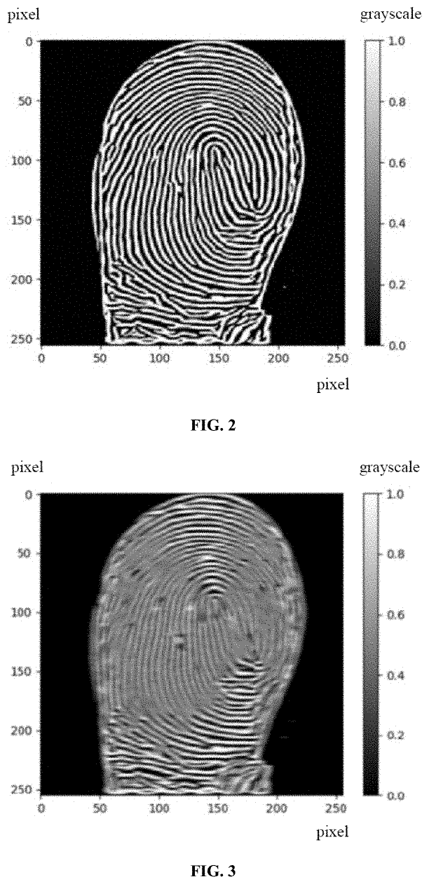

Taking a clear fingerprint image (resolution 256×256) shown in FIG. 2 as an example, the image actually captured by the sensor component may be a blurred fingerprint image shown in FIG. 3 due to the movement of the finger during imaging.

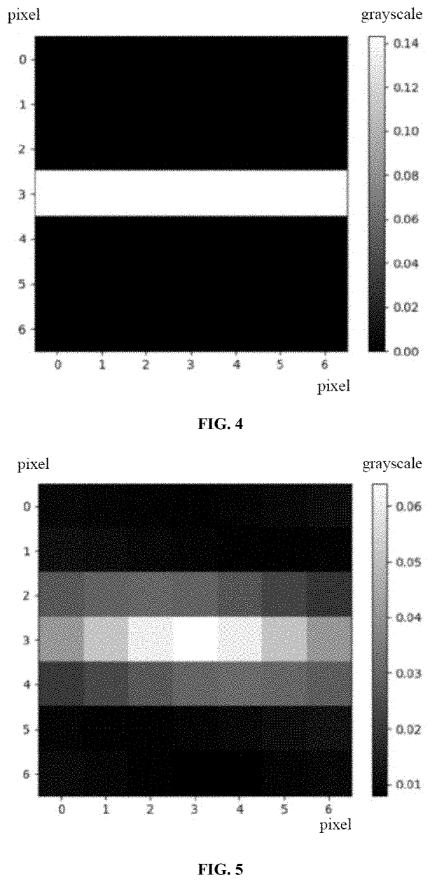

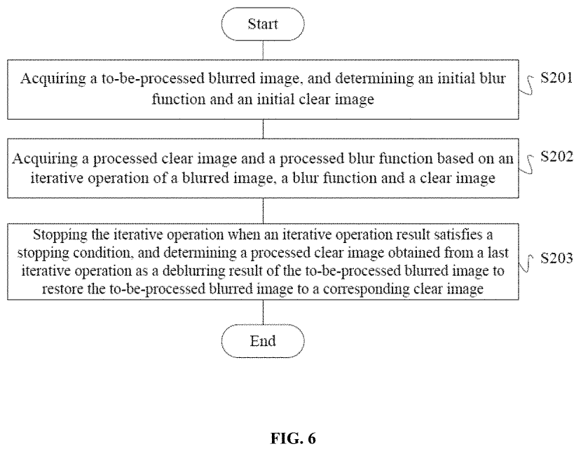

Theoretically, the blur function caused by a horizontal movement of the finger is shown in FIG. 4. An optimal blur function obtained from the solution according to some embodiment of the present disclosure is shown in FIG. 5. It can be seen that by adopting the solution according to some embodiment, the optimal blur function that is very close to a theoretical result can be obtained.

In a moving blur scene, the optimal blur function finally obtained can be expressed by formula (4):

$$h ( x ) \text{∼} rect ( \frac{x}{{d}_{s m e a r}} ) \qquad ( 4 )$$

wherein rect( ) represents a rectangular function; dₛₘₑₐᵣ represents a moving distance of the captured object within a single exposure time.

In some embodiment, a linear movement of the captured object within the single exposure time will cause tailing in the image. The greater the distance the capture object moves within the single exposure time, the more serious the tailing in the captured image. Specifically, a moving distance of the captured object within the single exposure time can be calculated according to formula (5):

dₛₘₑₐᵣ(t)=υ·tₑₓₚ (5)

wherein υ represents a moving speed of the captured object, and tₑₓₚ represents an exposure time.

Thus, some embodiment of the present disclosure can find out the blur function caused by the movement of the object based on an iterative algorithm, so as to facilitate later processing, such as deblurring. Specifically, the clear image is calculated from the blurred image by a deconvolution operation. Further, when the similarity between two processed clear images obtained from two consecutive times of iterative operations is higher than the preset threshold, it indicates that a restoration effect of the last iterative operation is better and tends to be stable, thus the clear image obtained from the last iterative operation can be determined as an optimal clear image, and the blur function obtained from the deconvolution operation in the last iterative operation can be determined as an optimal blur function for deblurring the captured blurred image.

Compared with solutions taking a fixed number of times of iterative operation as the stopping condition, taking an image similarity as the stopping condition can obtain a better deblurring effect. In particular, too many or too few times of iterative operations may affect the quality of the blur function and a restoration degree of the blurred image. Therefore, the deblurring effect of the image processed by taking the fixed number of times of iterative operations as the stopping condition is not necessarily the best. Based on this, some embodiment of the present disclosure takes the image similarity as the stopping condition, and determines a stopping time according to a real-time processing effect of the iterative operation, thereby obtaining a clearer image with higher quality and a better optimal blur function.

In some embodiment, in response to obtaining the processed optimal blur function, blurred fingerprint images currently captured by the sensor component may be deblurred based on the optimal blur function to obtain corresponding clear fingerprint images.

Specifically, a blurred image to be processed can be obtained, and then the blurred image to be processed is deblurred and restored to a corresponding clear image based on the optimal blur function.

In some embodiment, the clear image can be restored by following formula (6):

\tilde{ƒ}(x)=g(x)*⁻¹h(x) (6)

wherein \tilde{ƒ}(x) represents the clear image obtained from restoration, g(x) represents the blurred image to be processed, h(x) represents the optimal blur function, and *⁻¹ represents the deconvolution operation.

In some embodiment, for each blurred fingerprint image captured by the sensor component, the above method can be used to determine the optimal blur function suitable for the currently captured blurred fingerprint image, and then based on the optimal blur function, a deblurring operation is performed on the blurred fingerprint image currently captured by the sensor component to obtain a corresponding clear fingerprint image.

FIG. 6 shows a flow chart of a method for processing an image according to an embodiment of the present disclosure.

S201, acquiring a to-be-processed blurred image, and determining an initial blur function and an initial clear image.

S202, acquiring a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation.

S203, stopping the iterative operation when an iterative operation result satisfies a stopping condition, and determining a processed clear image obtained from a last iterative operation as a deblurring result of the to-be-processed blurred image to restore the to-be-processed blurred image to a corresponding clear image.

In some embodiment, the stopping condition at least includes that a similarity between two processed clear images respectively obtained from two adjacent iterative operations is greater than or equal to a preset threshold.

For specific content of the iterative operation and the stopping condition, reference may be made to relevant description in the embodiment shown in FIG. 1, which is not repeated here.

In some embodiment, in S201, after receiving the to-be-processed blurred image, a blur degree of the blurred fingerprint image may be determined first. If the blur degree of the blurred fingerprint image exceeds a preset critical value, S102 is executed; otherwise, a fingerprint identification operation is directly performed on the blurred fingerprint image.

Specifically, in S201 and S101, the preset critical value may be determined according to whether required information can be identified from the original image. For example, if the blur degree of the blurred fingerprint image reaches a certain value, the probability that the fingerprint information cannot be identified from the blurred fingerprint image exceeds 80%, then this value is determined as the preset critical value.

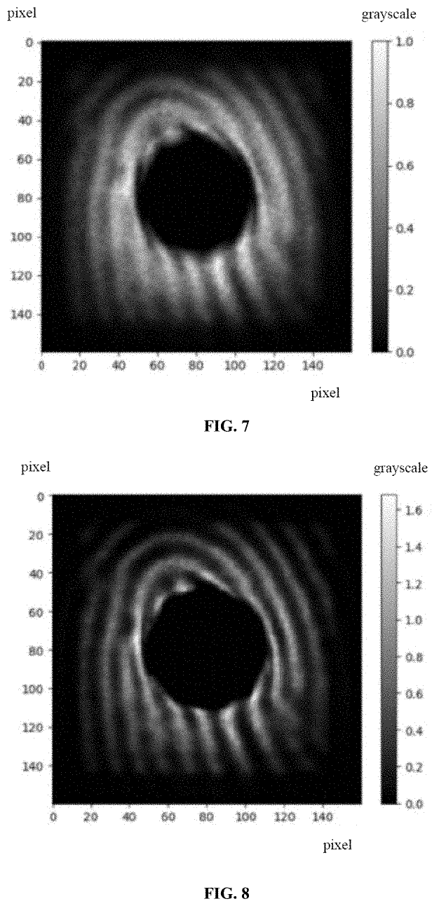

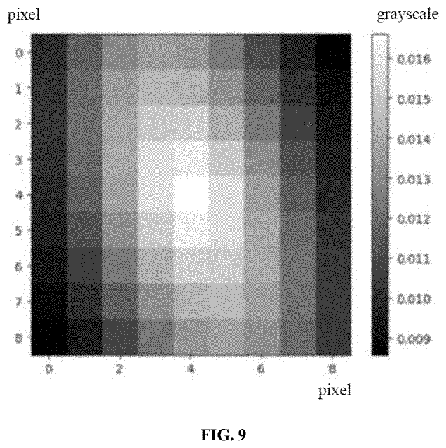

Taking a blurred fingerprint image shown in FIG. 7 (resolution 160×160) as an example, using the method according to above embodiment shown in FIG. 1, an optimal blur function shown in FIG. 9 (with a size of 9×9 pixels) and a clear fingerprint image shown in FIG. 8 can be obtained at the same time. By comparing FIG. 7 and FIG. 8, it can be seen that the blur degree of the fingerprint image is greatly reduced. In some embodiment, the number of times of iterative operations for obtaining the clear fingerprint image shown in FIG. 8 is 10.

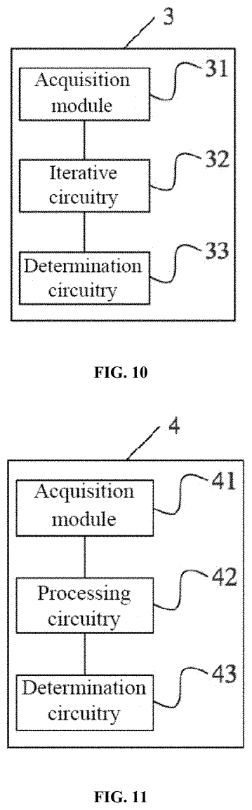

FIG. 10 is a schematic diagram showing a structure of an apparatus 3 for processing a blur function used with an imaging module according to an embodiment of the present disclosure. Those skilled in the art understand that the apparatus 3 for processing the blur function used with the imaging module described in this embodiment can be used to implement the method described in the embodiment shown in FIG. 1.

Specifically, the apparatus 3 may include an acquisition module 31 and an iterative circuitry 32. The acquisition module 31 is configured to acquire a blurred image and determine an initial blur function and an initial clear image. The iterative circuitry 32 is configured to acquire a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation. Further, the apparatus includes a determination circuitry 33. The determination circuitry 33 is configured to stop the iterative operation when an iterative operation result satisfies a stopping condition, and determine a processed blur function obtained from the last iterative operation as an optimal blur function. In some embodiment, the acquisition module 31 may be an acquisition circuitry.

In some embodiment, the stopping condition at least includes that a similarity between two processed clear images respectively obtained from two adjacent iterative operations is greater than or equal to a preset threshold.

For more details on the working principle and working mode of the apparatus 3 for processing the blur function, reference may be made to above related description with reference to FIG. 1, which will not be repeated here.

FIG. 11 is a schematic diagram showing a structure of an apparatus 4 for processing an image according to an embodiment of the present disclosure. Those skilled in the art understand that the apparatus 4 for processing the image can be used to implement the method described in the embodiment shown in FIG. 6.

Specifically, the apparatus 4 may include an acquisition module 41 and a processing circuitry 42. The acquisition module 41 is configured to acquire a to-be-processed blurred image and determine an initial blur function and an initial clear image. The processing circuitry 42 is configured to acquire a processed clear image and a processed blur function based on an iterative operation of a blurred image, a blur function and a clear image. The initial blur function is applied as the blur function of a first iterative operation, and the initial clear image is applied as the clear image of the first iterative operation. From a second iterative operation, the processed clear image and the processed blur function acquired from a previous iterative operation are applied as the clear image and the blur function of a next iterative operation. Further, the apparatus 4 includes a determination circuitry 43. The determination circuitry 43 is configured to stop the iterative operation when an iterative operation result satisfies a stopping condition, and determine a processed clear image obtained from a last iterative operation as a deblurring result of the to-be-processed blurred image to restore the to-be-processed blurred image to a corresponding clear image. In some embodiment, the acquisition module 41 may be an acquisition circuitry.

In some embodiment, the stopping condition at least includes that a similarity between two processed clear images respectively obtained from two adjacent iterative operations is greater than or equal to a preset threshold.

For more details on the working principle and working mode of the apparatus 4 for processing the blur function, reference may be made to above related description with reference to FIG. 6, which will not be repeated here.

Another embodiment of the present invention provides an imaging device. The imaging device includes an imaging module and a processing module. The imaging module is configured to capture a to-be-processed blurred image, and the processing module is configured to deblur and restore the to-be-processed blurred image to a corresponding clear image.

In some embodiments, the imaging module may include an image capturing apparatus, such as a fingerprint or palmprint capturing apparatus. The fingerprint or palmprint capturing apparatus may be used in mobile phone, tablet PC, electronic door lock, household electrical appliances, etc.

In some embodiments, the processing module may include a microprocessor, and/or a digital signal processor (DSP), etc.

In some embodiment, the processing module is configured to implement the method shown in FIG. 6 to deblur and restore the to-be-processed blurred image to a corresponding clear image.

In some embodiment, the imaging device may further include a blur function processing module. The blur function processing module is coupled with the imaging module and the processing module, and the blur function processing module is configured to implement the above-mentioned method to determine the optimal blur function. The optimal blur function is transmitted to the processing module, and the processing module performs a deblurring operation on the to-be-processed blurred image according to the optimal blur function. For example, the processing module may obtain a corresponding clear image based on the formula (6) in the foregoing embodiment.

In some embodiment, the imaging device may be a fingerprint imaging apparatus, and the blurred image captured by the imaging module may be a blurred fingerprint image. Correspondingly, the deblurred and restored clear image processed by the blur function processing module and the processing module is a clear fingerprint image.

By adopting the scheme of the embodiment, the captured blurred image can be deblurred, and the clear image can be obtained without repeated capturing operations. Thus, the imaging and identification efficiency of the fingerprint imaging apparatus can be improved, and an identification time can be shortened.

Furthermore, another embodiment of the present disclosure provides a storage medium. The storage medium has computer instructions stored therein, and the computer instructions are executed to perform steps of the method according to the embodiment as shown in FIG. 1 or FIG. 6. In some embodiments, the storage medium may include a computer readable storage medium, such as a non-volatile memory or a non-transitory memory. The computer readable storage medium may include a Read Only Memory (ROM), a Random Access Memory (RAM), a magnetic disk or an optical disk.

It should be noted that the relational terms herein such as first and second are used only to differentiate an entity or operation from another entity or operation, and do not require or imply any actual relationship or sequence between these entities or operations. In addition, term “comprise”, “include”, or any other variant thereof aims to cover non-exclusive “include”, so that a process, method, object, or terminal device that comprises a series of elements not only comprises the elements, but also comprises other elements that are not definitely listed, or further comprises inherent elements of the process, method, object, or terminal device. In a case in which there are no more limitations, an element defined by the sentence “comprise . . . ” or “include . . . ” does not exclude the case in which other elements further exist in a process, method, or object, or terminal device that comprises the element. In addition, in this text, “greater than”, “less than”, “exceed”, and the like are understood as not including the number. “More”, “fewer”, “within”, and the like are understood as including the number.

A person skilled in the art should understand that the foregoing embodiments may provide a method, an apparatus, a device, or a computer program product. These embodiments may use forms of full hardware embodiments, full software embodiments, or embodiments of a combination of software and hardware aspects. All or some of the steps in the methods involved in the foregoing embodiments may be implemented by using a program instructing relevant hardware. The program may be stored in a computer device readable storage medium for performing all or some of the steps of the methods in the foregoing embodiments. The computer device includes but is not limited to: a personal computer, a server, a general-purpose computer, a dedicated computer, a network device, an embedded device, a programmable device, an intelligent mobile terminal, an intelligent home device, a wearable intelligent device, an in-vehicle intelligent device, and the like. The storage medium includes but is not limited to: a RAM, a ROM, a magnetic disk, a magnetic tape, an optical disc, a flash memory, a USB flash drive, a removable hard disk, a memory card, a memory stick, network server storage, network cloud storage, and the like.

Various logical modules and circuits described with reference to the embodiments disclosed with reference to this specification may be implemented or executed by using a general purpose processor, a digital signal processor (DSP), an application-specific integrated circuit (ASIC), a field-programmable gate array (FPGA) or another programmable logical component, a discrete gate or transistor logic, a discrete hardware component, or any combination designed to implement functions described in this specification. The general purpose processor may be a microprocessor. However, in an alternative solution, the processor may be any conventional processor, controller, micro controller, or state machine. The processor may be any conventional processor, controller, micro controller, or state machine. The processor may be any conventional processor, controller, micro controller, or state machine. The processor may be alternatively implemented as a combination of computing devices, for example, a combination of a DSP and microprocessor, multiple microprocessors, one or more microprocessor coordinated with a core of a DSP, or any other such configuration.

Steps of the method or algorithm described with reference to the embodiments disclosed in this specification may be directly reflected in hardware, a software module executed by the processor, or a combination of the two. The software module may reside in a RAM memory, a flash memory, a ROM memory, an EPROM memory, an EEPROM memory, a register, a hard disk, a removable disk, a CD-ROM, or a storage medium in any other form known in the art. Exemplarily, the storage medium is coupled to the processor, so that the processor can read information from and write information into the storage medium. In an alternative solution, the storage medium may be integrated into the processor. The processor and the storage medium may reside in the ASIC. The ASIC may reside in a user terminal. In an alternative solution, the processor and the storage medium may reside in the user terminal as discrete components.

The foregoing embodiments are described with reference to flowcharts and/or block diagrams of the method, the device (the system), and the computer program product in the embodiments. It should be understood that computer program instructions may be used for implementing each process and/or each block in the flowcharts and/or the block diagrams and a combination of a process and/or a block in the flowcharts and/or the block diagrams. These computer program instructions may be provided to a computer of a computer device to generate a machine, so that instructions executed by the processor of the computer device generate an apparatus configured to implement specific functions in one or more processes in the flowcharts and/or in one or more blocks in the block diagrams.

These computer program instructions may further be stored in a computer device readable memory that can instruct the computer device to work in a specific manner, so that the instructions stored in the computer device readable memory generate an artifact that includes an instruction apparatus. The instruction apparatus implements specific functions in one or more processes in the flowcharts and/or in one or more blocks in the block diagrams.

These computer program instructions may further be loaded onto a computer device, so that a series of operations and steps are performed on the computer device, thereby generating computer-implemented processing. Therefore, the instructions executed on the computer device provide steps for implementing specific functions in one or more processes in the flowcharts and/or in one or more blocks in the block diagrams.

Although the present disclosure has been disclosed above, the present disclosure is not limited thereto. Any changes and modifications may be made by those skilled in the art without departing from the spirit and scope of the present disclosure, and the scope of the present disclosure should be determined by the appended claims.

1. A method for processing an image, comprising:
acquiring a to-be-processed blurred image, and determining an initial blur function and an initial clear image; and
acquiring a processed clear image and a processed blur function based on an iterative operation of a blurred image, a blur function and a clear image, wherein the initial blur function is applied as the blur function of a first iterative operation, and the initial clear image is applied as the clear image of the first iterative operation, wherein from a second iterative operation, the processed clear image and the processed blur function acquired from a previous iterative operation are applied as the clear image and the blur function of a next iterative operation.

2. The method according to claim 1, further comprising: stopping the iterative operation when an iterative operation result satisfies a stopping condition, and determining a processed clear image obtained from a last iterative operation as a deblurring result of the to-be-processed blurred image, so as to restore the to-be-processed blurred image to a corresponding clear image.

3. The method according to claim 2, further comprising: determining a processed blur function obtained from the last iterative operation as an optimal blur function.

4. The method according to claim 2, wherein the stopping condition at least comprises that a similarity between two processed clear images respectively obtained from two adjacent iterative operations is greater than or equal to a preset threshold.

5. The method according to claim 1, wherein the blur function comprises a matrix, and determining the initial blur function comprises assigning a random value to each element of the matrix to obtain the initial blur function.

6. The method according to claim 5, wherein the random value ranges from 0 to 1.

7. The method according to claim 5, wherein the to-be-processed blurred image is captured by an imaging module, and numbers of rows and numbers of columns of the matrix are determined according to a size of a light source of the imaging module.

8. The method according to claim 1, wherein determining the initial clear image comprises: determining the to-be-processed blurred image as the initial clear image.

9. The method according to claim 1, wherein acquiring a processed clear image and a processed blur function based on an iterative operation of a blurred image, a blur function and a clear image comprises:
performing a deconvolution operation iteratively based on the blurred image, the blur function and the clear image to obtain the processed clear image and the processed blur function.

10. The method according to claim 9, wherein performing a deconvolution operation iteratively based on the blurred image, the blur function and the clear image to obtain the processed clear image and the processed blur function comprises:
obtaining the processed clear image in each iterative operation according to following formula:
$${f}_{k + 1} ( x ) = \{ [ \frac{g ( x )}{{f}_{k} ( x ) * {h}_{k} ( x )} ] * {h}_{k} ( - x ) \} \times {f}_{k} ( x ) ; \qquad$$
wherein, k represents a kth iterative operation, and k≥0, ƒₖ₊₁(x) represents a processed clear image obtained from a (k+1)th iterative operation, ƒₖ(x) represents a processed clear image obtained from the kth iterative operation, g(x) represents the blurred image, hₖ(x) represents a processed blur function obtained from the kth iterative operation, hₖ(−x) represents an inversion of the processed blur function obtained from the kth iterative operation, * represents a convolution operation, and x represents a multiplication operation; and
obtaining the processed blur function in each iterative operation according to following formula:
$${h}_{k + 1} ( x ) = \{ [ \frac{g ( x )}{{f}_{k} ( x ) * {h}_{k} ( x )} ] * {f}_{k} ( - x ) \} \times {h}_{k} ( x ) ; \qquad$$
wherein hₖ₊₁(x) represents a processed blur function obtained from a (k+1)th iterative operation, and ƒₖ(−x) represents an inversion of the processed clear image obtained from the kth iterative operation.

11. The method according to claim 1, wherein a processed clear image obtained from each iterative operation satisfies following condition:
a grayscale of each pixel in the processed clear image is greater than zero.

12. The method according to claim 1, wherein the blur function comprises a matrix, and a processed blur function obtained from each iterative operation satisfies following conditions:
a value of each element in the processed blur function is greater than zero;
the processed blur function satisfies a normalization condition; and
numbers of rows and numbers of columns of the processed blur function remains constant.

13. The method according to claim 2, wherein the stopping condition comprises: a preset number of iterative operations are performed.

14. The method according to claim 13, wherein stopping the iterative operation when an iterative operation result satisfies a stopping condition comprises:
when the preset number of iterative operations are reached, but a similarity between a processed clear image obtained from a last iterative operation and a processed clear image obtained from a previous iterative operation adjacent to the last iterative operation is less than a preset threshold, continuing with the iterative operation until the similarity between two processed clear images respectively obtained from two adjacent iterative operations is greater than or equal to the preset threshold.

15. An apparatus for processing an image, comprising:
an acquisition module, configured to acquire a to-be-processed blurred image and determine an initial blur function and an initial clear image; and
a processing circuitry, configured to acquire a processed clear image and a processed blur function based on an iterative operation of a blurred image, a blur function and a clear image, wherein the initial blur function is applied as the blur function of a first iterative operation, and the initial clear image is applied as the clear image of the first iterative operation, wherein from a second iterative operation, the processed clear image and the processed blur function acquired from a previous iterative operation are applied as the clear image and the blur function of a next iterative operation.

16. The apparatus according to claim 15, further comprising:
a determination circuitry, configured to stop the iterative operation when an iterative operation result satisfies a stopping condition, and determine a processed clear image obtained from a last iterative operation as a deblurring result of the to-be-processed blurred image, so as to restore the to-be-processed blurred image to a corresponding clear image.

17. The apparatus according to claim 16, wherein the determination circuitry is further configured to determine a processed blur function obtained from the last iterative operation as an optimal blur function.

18. The apparatus according to claim 16, wherein the stopping condition at least comprises that a similarity between two processed clear images respectively obtained from two adjacent iterative operations is greater than or equal to a preset threshold.

19. A non-transitory storage medium having computer instructions stored therein, wherein the computer instructions are executed to perform steps of the method according to claim 1.

20. An imaging device, comprising:
an imaging module, configured to capture a to-be-processed blurred image; and
a processing module, configured to perform the method of claim 1 to deblur and restore the to-be-processed blurred image to a corresponding clear image.
